(19) United States
(12) Patent Application Publication
(10) Pub. No.: US 2015/0178075 A1
(43) Pub. Date: Jun. 25, 2015

(54) ENHANCING UNDERSTANDABILITY OF CODE USING CODE CLONES

(71) Applicant: Infosys Limited, Bangalore (IN)

(72) Inventors: SATYA PRATEEK BOMMARAJU, BANGALORE (IN); KAUSAR MUNSHI, BANGALORE (IN)

(21) Appl. No.: 14/577,700

(22) Filed: Dec. 19, 2014

(30) Foreign Application Priority Data
Dec. 20, 2013 (IN) 5993/CHE/2013

(51) Int. Cl. G06F 9/44

(52) U.S. Cl. CPC G06F 8/73; G06F 8/751

(57) ABSTRACT

A method of a enhancing code understandability through a server device includes identifying, at a processor associated with the one or more server devices, a patch of code in response to a request and searching, at a processor associated with the one or more server devices, for another patch of code similar to the patch of code. Further, the patch of code and another patch of code are parsed. Comments associated with the parsed patches of code are identified. An association between the patches of code and comments is created. A ranking for the comments is generated and a user associated with the request is identified. The ranking is presented to the user through a client device.

### RELATED APPLICATION DATA

This application claims priority to India Patent Application No. 5993/CHE/2013, filed Dec. 20, 2013, the disclosure of which is hereby incorporated by reference in its entirety.

### FIELD OF THE INVENTION

The present invention relates to a method and system for comparing patches of code in a program source code file to determine similarity.

### BACKGROUND

Maintenance engineers find it difficult to understand patches of code written by other engineers. Techniques like static analysis and reverse engineering have been previously used to assess the properties of the code such as representation of the code's architecture or abstraction of the code.

In order to understand code segments, automated documentation generators that create flow charts, inheritance diagrams, tables of contents, indexes, topic lists, and cross-references, have are being used. Further, maintenance engineers tend to seek advice of developers and or experts to understand code segments.

### SUMMARY

Disclosed are a method, an apparatus and/or a system of enhancing understandability of code using code clones.

A method of a server device includes identifying, at a processor associated with the one or more server devices, a patch of code in response to a request and searching, at a processor associated with the one or more server devices, for another patch of code similar to the patch of code. Further, the patch of code and another patch of code are parsed. Comments associated with the parsed patches of code are identified. An association between the patches of code and comments is created. A ranking for the comments is generated and a user associated with the request is identified.

A system of enhancing code understandability includes a server associated with a processor and a computer network associated with the processor. The processor receives a request to enhance code understandability through the computer network and identifies a patch of code associated with a user request. Further, the processor searches over the computer network through a code clone detection engine for another patch of code similar to the patch of code associated with the user request. A parser associated with the server parses the patch of code and another patch of code. The server identifies through a comment extraction engine comments associated with the parsed patches of code and stores the comments in a project repository. A comment ranker associated with the server device generates a ranking for the comments identified by the comment extraction engine. A report generation tool associated with the computer network generates a report.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a system of enhancing code understandability, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of enhancing code understandability, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of enhancing understandability of code using code clones. Although the present embodiments have been described with reference to specific example embodiments, it will be evident that various modifications and changes may be made to these embodiments without departing from the broader spirit and scope of the various embodiments.

According to one or more embodiments, a method of a server device may include identifying, at a processor associated with the one or more server devices, a patch of code associated with a project and searching, at a processor associated with the one or more server devices, for another patch of code similar to the patch of code.

The method of the server device may further include parsing the patches of code including the patch of code and the another patch of code.

In an example embodiment, code may be parsed to find other similar code. When similar code may be found through the parsing of code, comments associated with similar code patches may be used to understand the code. Comments associated with code may help maintenance engineers understand code that other developers developed. Also, developers may not repeat comments associated with a certain portion of code when the portion of code repeats. If a certain portion of code is repeated then the comments may be omitted for the repeating portion of code. Thereby scanning the code to find similar code segments to find relevant comments may be advantageous.

Further, an objective of parsing the code may be to achieve an improved understanding of code using a similar code patch that may be present elsewhere in a project. The code may be a sub-set of the project.

Comments associated with the parsed patches code may be identified. Further, an association between the parsed patches of code and the comments may be created. A ranking may be generated for the identified comments.

In one or more embodiments, a user may seek to find patches of code similar to a certain of patch of code through a request. In an example embodiment, the request may be generated though a user interface of a portal

In an example embodiment, a user may seek to find patches of code similar to a certain of patch of code through a request. In response to the request, a server device may identify a patch of code associated with the request and search for another patch of code similar to the patch of code. In an example embodiment, the server may search for another patch of code through the server associated with a computer database over a computer network. Further, the server device may further parse the patches of code including the patch of code and the another patch of code. The server may identify comments associated with the parsed patches code. Further, an association between the parsed patches of code and the comments may be created. A ranking may be generated for the identified comments. The ranking that is generated may be presented to the user that initiated the request.

In one or more embodiments, the association may be represented by a table. For example, the table may have two columns. A first column containing a code segment and a second column having comments associated with the code segment. The code segment may be repeated at one or more instances in the project. The comments may listed based on a ranking in the second column.

In an example embodiment, the user may generate the request to find patches of code similar to a certain patch of code in order to enhance understandability. Engineers writing code may add comments for patches of code to enhance understandability. Similar patches of code may have different comments associated. Comments associated with similar patches may vary due to various reasons including different engineers coding, mood of the engineer coding, and context of usage of the patch of code.

In an example embodiment, similar patches of code may be searched across projects and/or within a project. Further, similar patches of code may be searched for in project repository. In an example embodiment, the request may specify the location to search for similar patches of code on a computer database.

In previous systems used to enhance understandability of code one of the main problems faced was relevancy of results from tests like static analysis. In contrast, the system disclosed herein finds similar patches of code that have comments. Therefore, poorly documented code can be understood using the comments placed at other similar patches of code.

In one or more embodiments, a user may raise a request for understanding a code segment whose functionality is unknown. The code segment may be input along with the request to a server to find similar patches of code. A source code repository may be maintained. The input code segment may be compared to the contents of the source code repository.

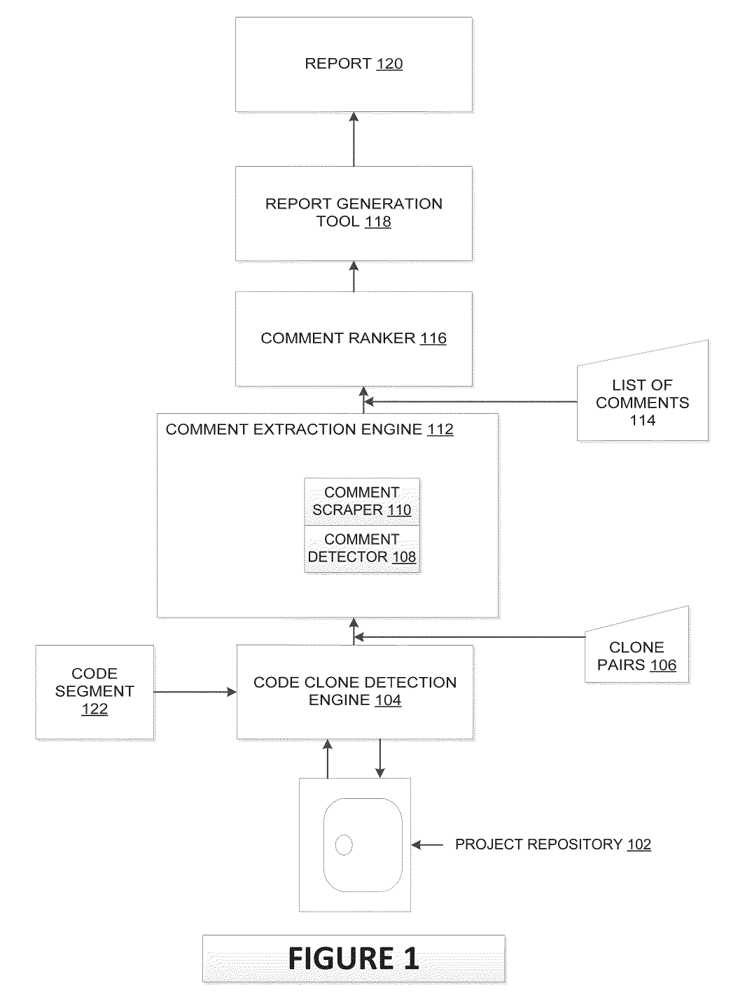

FIG. 1 shows a system of enhancing code understandability, according to one or more embodiments. A user may raise a request for code segment 122. Code segment 122 may refer to a segment and/patch of code. A user may raise a request for better understanding of the segment and/or patch of code.

Code Clone Detection Engine 104 associated with a computer server connected to a network 200 may receive a request from the user. Code clone detection engine 104 may take as input the code segment 122. The code clone detection engine 104 may match the code segment 104 against the contents of a project repository 102. The project repository 102 may be used to store and save the code associated with a software and/or a project.

The matching by the code clone detection engine 104 may be to identify all the clones and/or similar segments available in the project repository 102. The matching may generate an output which consists of a list of matching pairs, with the details regarding code segments that are part of the output.

Comment Extraction Engine 112 may include a comment scraper 110 and comment detector 108. The output of the Code Clone Detection Engine 104 may act as the input to the Comment Extraction Engine 112 i.e., the list of matched pairs. Comment Detector 108 may look for code comments available in the matched pairs.

Comment Scraper 110 may extract the comments from the code segments and/or code patches. Further, the comment scraper 110 may maintain a separate list of comments. The lists maintained by the comment scraper 110 may be specific to a particular code segment of the input file, i.e., all the clones of a specific module may be identified and there clones are maintained in a list. Thus, the output of the comment extraction engine 112 may be a list of comments 114. The list of comments 114 may act as input to a comment ranker 116.

Comment Ranker 116 may rank the list of comments 114 according to a various criteria. In one or more embodiments, the various criteria may include length of the comment and similarity index of the code segments. Length of the comment may determine the amount of feedback given to the request. The longer the comment the more information may be provided to the user. Similarity of the code segments may determine the relevancy of the comments extracted. The more similar the code segments the more relevant the comments may be.

Other metrics may also be used such as a token based metrics that look for the function, method, variable names with words in the comments to improve the relevancy. Thus, the comment ranker 116 re-orders the list on the basis of the ranks awarded to the comments.

The ranking generated by the comment ranker 116 are provided to a report generation tool 118. The Report Generation Tool 118 then may display the ordered list in the form of a report 120 to a user who generated the request.

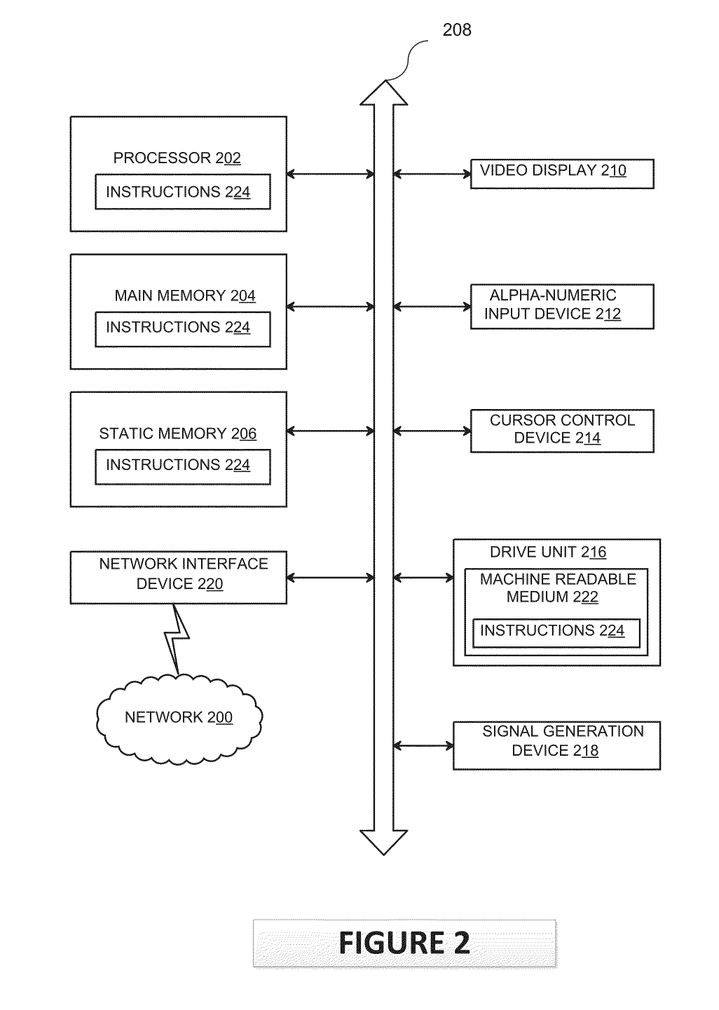

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

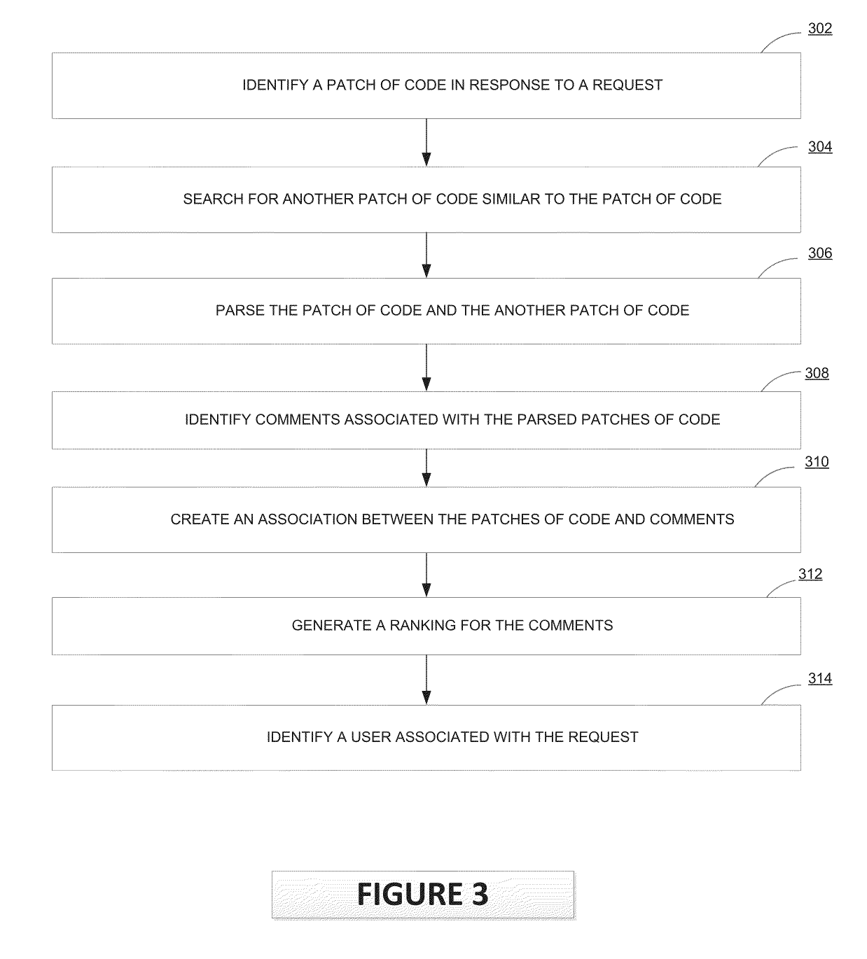

FIG. 3 is a process flow diagram detailing the operation of a method of a server to enhance the understandability of code according to one or more embodiments. A method of a server to enhance the understandability of code may include identifying, at a processor associated with the one or more server devices, a patch of code in response to a request 302 and searching, at a processor associated with the one or more server devices, for another patch of code similar to the patch of code 304. Further, parsing the patch of code and another patch of code 306.

A processor associated with the one or more server devices may identify comments associated with the parsed patches of code 308 and create an association between the patches of code and comments 310. A ranking for the comments may be generated 312. The user raising the request may be identified 314. The ranking may be provided through a client device associated with the user to be presented to the user.

In one or more embodiments, a method of a server device may include identifying a patch of code in response to a request and searching for another patch of code similar to the patch of code. The patch of code and another patch of code may be parsed to identify comments associated with the parsed patches of code. An association between the patches of code and the comments may be created. Further, a ranking for the comments may be generated. A user associated with the request may be identified to present the ranking to the user through a client device.

In an example embodiment, the ranking for the comments may be stored in a project repository. In one or more embodiments, the project repository may be associated with one of a physical and virtual memory. Further, the project repository may be associated with a computer database wherein the code is stored. The computer database may be a secure access location.

In one or more embodiments, a system of enhancing code understandability may include a server associated with a processor and a computer network associated with the processor. The processor may receive a request to enhance code understandability through the computer network. The processor in response to the request may identify a patch of code associated with a user request. Further, the processor may search over the computer network through a code clone detection engine for another patch of code similar to the patch of code associated with the user request. Still further, a parser associated with the server may parse the patch of code and another patch of code. The server may identify through a comment extraction engine comments associated with the parsed patches of code and store the comments in a project repository. A comment ranker associated with the server device may generate a ranking for the comments identified by the comment extraction engine. Also, a report generation tool associated with the computer network may generate a report.

Further, the comment extraction engine may be associated with a comment scraper and comment detector. The report may be presented to the user through a user interface.

The user interface may be one of a computer screen, mobile device, and user interface of a portal. The report may be presented to the user interface of a portal in case the request may be generated from the user interface of a portal. In one or more embodiments, the report may be presented to the user associated with the request. In en example embodiment, the report may be presented as input to a semantic analysis tool.

The ranking generated by the comment ranker may be stored in the project repository. The request to enhance code understandability may include the patch of code.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A method of a server device comprising:
identifying, at a processor associated with the one or more server devices, a patch of code in response to a request;
searching, at a processor associated with the one or more server devices, for at least another patch of code similar to the patch of code;
parsing the patch of code and another patch of code;
identifying, at a processor associated with the one or more server devices, comments associated with the parsed patches of code;
creating, at a processor associated with one or more server devices, an association between the patches of code and comments;
generating, using a processor associated with the one or more server devices, a ranking for the comments; and
identifying, using a processor associated with the one or more server devices, a user associated with the request.

2. The method of the server device further comprising:
providing the ranking, to a client device associated with the user for presentation.

3. The method of claim 1 further comprising:
storing the ranking for the comments in a project repository.

4. The method of claim 3, wherein the project repository is associated with one of a physical and virtual memory.

5. A system of enhancing code understandability comprising:
a server associated with a processor;
a computer network associated with the processor,
wherein the processor receives a request to enhance code understandability through the computer network,
wherein the processor identifies a patch of code associated with a user request,
wherein the processor searches over the computer network through a code clone detection engine for another patch of code similar to the patch of code associated with the user request;
a parser associated with the server to parse the patch of code and another patch of code wherein the server identifies through a comment extraction engine comments associated with the parsed patches of code and stores the comments in a project repository;
a comment ranker associated with the server device to generate a ranking for the comments identified by the comment extraction engine; and
a report generation tool associated with the computer network to generate a report.

6. The system of claim 5, wherein the comment extraction engine is associated with a comment scraper and comment detector.

7. The system of claim 5, wherein the report is presented to the user through a user interface.

8. The system of claim 6, wherein the user interface is one of a computer screen, mobile device, and user interface of a portal.

9. The system of claim 5, wherein the ranking generated by the comment ranker are stored in the project repository.

10. The system of claim 5, wherein the request to enhance code understandability includes the patch of code.

11. The system of claim 5, wherein the report is presented to the user associated with the request.

12. The system of claim 5, wherein the report is presented as input to a semantic analysis tool.
